(19) United States
(12) Patent Application Publication
(10) Pub. No.: US 2025/0166498 A1
(43) Pub. Date: May 22, 2025

(54) METHOD OF PREDICTING TRAFFIC EVENTS BASED ON SPATIO-TEMPORAL HAWKES PROCESS

(71) Applicants: Hangzhou Dianzi University, Hangzhou (CN); HDU Binjiang Institute Co., Ltd., Hangzhou (CN); HDU Information Engineering College, Lin'an District (CN)

(72) Inventors: Dongjing WANG, Hangzhou (CN); Xin ZHANG, Hangzhou (CN); Dongjin YU, Hangzhou (CN); Haiping ZHANG, Hangzhou (CN); Qiang XIAO, Hangzhou (CN); Runze WU, Hangzhou (CN); Zhengzhe XIANG, Hangzhou (CN); Shuiguang DENG, Hangzhou (CN)

(21) Appl. No.: 18/925,383

(22) Filed: Oct. 24, 2024

(30) Foreign Application Priority Data
Nov. 22, 2023 (CN) 202311564862.2

(51) Int. Cl. G08G 1/01

(52) U.S. Cl. CPC G08G 1/0129; G08G 1/0133

(57) ABSTRACT

Provided is a method of predicting traffic events based on a spatio-temporal Hawkes process, which includes the following steps: step 1: collecting historical spatio-temporal data of all types of traffic events; step 2: establishing a spatio-temporal Hawkes process model, which can describe a correlation and probability intensity of the spatio-temporal data; step 3: estimating parameters of the spatio-temporal Hawkes process model by training the spatio-temporal data; step 4: using the trained model to predict traffic events. The technical scheme can use the spatio-temporal Hawkes process model to effectively solve the problems and challenges faced by the existing method of predicting traffic events, effectively capture the spatio-temporal correlation and accurately predict the occurrence of traffic events based on the spatio-temporal data.

### CROSS-REFERENCE TO RELATED APPLICATION

This patent application claims the benefit and priority of Chinese Patent Application No. 202311564862.2 filed with the China National Intellectual Property Administration on Nov. 22, 2023, the disclosure of which is incorporated by reference herein in its entirety as part of the present application.

### TECHNICAL FIELD

The present disclosure relates to the field of traffic event prediction, and in particular to a method of predicting traffic events based on a spatio-temporal Hawkes process, which uses the spatio-temporal Hawkes process to model the correlation between historical events in the traffic field and provide the prediction for occurrence probability of future events.

### BACKGROUND

The occurrence of traffic events has an important influence on traffic flow and traffic management. Accurate prediction of traffic events can help traffic management departments to take corresponding measures to reduce traffic congestion, improve traffic safety and provide more efficient traffic services.

At present, many studies have explored methods of predicting traffic events, but there are still some challenges, which are specifically as follows: (1) incomplete and inaccurate data: traffic event prediction usually depends on a large number of real-time and historical traffic data, including traffic flow, speed, road conditions, etc., however, there may be problems in the acquisition and quality of data, such as missing data, noise and errors, which will influence the accuracy and reliability of prediction; (2) challenges in dealing with the spatio-temporal correlation: a traffic event usually has an obvious spatio-temporal correlation, that is, events in a certain place may be influenced by events in surrounding places, however, it is often difficult for the traditional predicting methods to accurately capture and model the spatio-temporal correlation, resulting in inaccurate or unreliable predicting results; and (3) limitation by the complexity and the computational efficiency of the model: some existing methods of predicting traffic events use complex statistical models or machine learning algorithms, which require significant computational resources and time, limiting the feasibility and real-time availability of these methods in practical application.

### SUMMARY

The present disclosure provides a method of predicting traffic events based on a spatio-temporal Hawkes process, to overcome the shortcomings of the prior art. This method can effectively solve the problems and challenges faced by the existing method, accurately capture spatio-temporal correlation and accurately predict the occurrence of traffic events based on the spatio-temporal data.

The present disclosure provides a method of predicting traffic events based on a spatio-temporal Hawkes process, which specifically includes the following steps:
Step 1, collecting historical spatio-temporal data of all types of traffic events;
Step 2, establishing a spatio-temporal Hawkes process model, which can describe a correlation and a probability intensity of the spatio-temporal data;
Step 3, estimating parameters of the spatio-temporal Hawkes process model by training the spatio-temporal data;
Step 4, using the trained model to predict traffic events.

Preferably, in Step 1, the historical spatio-temporal data of n types of traffic events is E={E¹, E², . . . , E^{k}, . . . , Eⁿ}, a historical spatio-temporal sequence of a k-th type of traffic events is defined as E^{k}={e₁^{k}, e₂^{k}, . . . , eᵢ^{k}, . . . , e_{|E}_{ₖ}_{|}^{k}}, where eᵢ^{k}=(tᵢ^{k}, lᵢ^{k}), and tᵢ^{k} and lᵢ^{k}=(laᵢ^{k}, loᵢ^{k}) are timestamp information and spatial latitude and longitude information when a traffic event eᵢ^{k} occurs, respectively (laᵢ^{k} is longitude information of event eᵢ^{k}, and loᵢ^{k} is latitude information of event eᵢ^{k}).

Preferably, in Step 2, given the historical spatio-temporal data E of all n types of traffic events, the spatio-temporal Hawkes process model is constructed, and the probability intensity of the k-th target traffic event eⱼ^{k} occurring in the target timestamp tⱼ^{k} and the target spatial latitude and longitude lⱼ^{k} is modeled as:

$${λ}_{{e}_{j}^{k} \vert E} ( {t}_{j}^{k} , {l}_{j}^{k} ) = {f}_{l} ( {μ}_{k} + {\sum }_{{e}_{h}^{k} ∈ {E}^{k} , h < j} {f}_{1} ( {e}_{j}^{k} , {e}_{h}^{k} ) + {\sum }_{{e}_{m}^{{k}^{′}} ∈ E - {E}^{k} , m < j} {f}_{2} ( {e}_{j}^{k} , {e}_{m}^{{k}^{′}} ) ) ,$$

where μₖ is a base probability intensity for occurrence of the k-th type of traffic events e^{k},

$${\sum }_{{e}_{h}^{k} ∈ {E}^{k} , h < j} {f}_{1} ( {e}_{j}^{k} , {e}_{h}^{k} )$$

indicates an influence of a same type of historical traffic events eₕ^{k}∈E^{k} on a target traffic event eⱼ^{k}, f₁(·,·) is an influence function of the same type of traffic events,

$${\sum }_{{e}_{m}^{{k}^{′}} ∈ E - {E}^{k} , m < j} {f}_{2} ( {e}_{j}^{k} , {e}_{m}^{{k}^{′}} )$$

is an influence of other types of historical traffic events eₘ^{k′}∈E−E^{k} on the target traffic event eⱼ^{k}, f₂(·,·) is an influence function of different types of traffic events, and fₗ(x)=1/(1+exp(−x)) is a logistic function used to ensure the non-negativity of the probability intensity.

An influence function of the same type of traffic events eₕ^{k}∈E^{k} on the target traffic event eⱼ^{k} is defined as:

$${f}_{1} ( {e}_{j}^{k} , {e}_{h}^{k} ) = φ ( {t}_{j}^{k} , {t}_{h}^{k} ) \cdot d ( {l}_{j}^{k} , {l}_{h}^{k} ) \cdot {γ}_{k} ,$$

where φ(tⱼ^{k}, tₕ^{k})=exp (−αₖ·(tⱼ^{k}−tₕ^{k}) indicates that the influence of the same type of historical traffic events decays exponentially with an increasing time interval, αₖ is a time attenuation degree coefficient for the influence of the same type (k) of events, d(lⱼ^{k}, lₕ^{k})=exp (−βₖ·\sqrt{(laⱼ^{k}−laₕ^{k})²+ (loⱼ^{k}−loₕ^{k})²}) indicates that the influence of the same type of historical traffic events decays exponentially with an increasing space interval, laⱼ^{k} and loⱼ^{k} are the spatial longitude and latitude information of the target traffic event, laₕ^{k} and loₕ^{k} are the longitude and latitude information of the same type of historical traffic events eₕ^{k}∈E^{k}, βₖ is a space attenuation degree coefficient for the influence of the same type of events (k), and γₖ is a real number parameter, which indicates whether the relationship between the same type of events is negatively correlated (suppression effect) or positively correlated (stimulation effect).

An influence function of other types of historical traffic events eₘ^{k′}∈E−E^{k} on the target traffic event eⱼ^{k} is defined as:

$${f}_{2} ( {e}_{j}^{k} , {e}_{m}^{{k}^{′}} ) = {φ}^{′} ( {t}_{j}^{k} , {t}_{m}^{{k}^{′}} ) \cdot {d}^{′} ( {l}_{j}^{k} , {l}_{m}^{{k}^{′}} ) \cdot {γ}_{k}^{{k}^{′}} ,$$

where φ′(tⱼ^{k}, tₘ^{k′})=exp (−αₖ·(tⱼ^{k}−tₘ^{k′})) indicates that the influence of different types of historical traffic events decays exponentially with the increasing time interval, α_{k′} is the time attenuation degree coefficient for the influence of a k′-th type of historical event on the k-th type of the target event,

$${d}^{′} ( {l}_{j}^{k} , {l}_{m}^{{k}^{′}} ) = exp ( {β}_{k}^{{k}^{′}} \cdot \sqrt{{( {la}_{j}^{k} , {la}_{m}^{{k}^{′}} )}^{2} + {( {lo}_{j}^{k} , {lo}_{m}^{{k}^{′}} )}^{2}} )$$

indicates that the influence of the same type of historical traffic events decays exponentially with the increasing space interval, laⱼ^{k} and loⱼ^{k} are the longitude and latitude information of the target space, laₘ^{k′} and loₘ^{k′} are the longitude and latitude information of different types of historical traffic events eₘ^{k}∈E−E^{k}, βₖ^{k′} is the space attenuation degree coefficient for the influence of the k′-th type of events on the k-th type of events, and γₖ^{k′} is a real number parameter, which indicates whether the relationship between different types of events is negatively correlated (suppression effect) or positively correlated (stimulation effect).

Preferably, in Step 3, an objective function for estimating the parameters of the spatio-temporal Hawkes process model is formally defined as:

$$O = {\sum }_{{E}^{k} ∈ E} {\sum }_{{e}_{j}^{k} ∈ {E}^{k}} log p ( {e}_{j}^{k} \vert E , {t}_{j}^{k} , {l}_{j}^{k} ) ,$$

where p(eⱼ^{k}|E, tⱼ^{k}, lⱼ^{k}) is a probability of occurrence of the k-th type of target traffic events eⱼ^{k} in time tⱼ^{k} and space lⱼ^{k} given the historical spatio-temporal data E of all n types of traffic events,
furthermore, the above objective function ( ) is maximally solved using a gradient descent optimization algorithm, so as to obtain the optimal values of all parameters and obtain the final spatio-temporal Hawkes process model.

Preferably, in Step 4, the process of predicting traffic events by using the trained model is defined as given time information t and space information l, the probabilities of occurrences of all n types of traffic events are calculated and sorted in a descending order of probability values, and finally the sorted event list and probability values are output.

The present disclosure has the following characteristics and beneficial effects.

The spatio-temporal Hawkes process proposed by the present disclosure can model the spatio-temporal correlation between traffic events more accurately, capture the triggering and propagation effects between traffic events, and help predict future events. In addition, the method provided by the present disclosure can process real-time traffic data and predict events according to the latest observation results, so as to capture the changes of traffic events in time and provide real-time prediction results. Finally, the method can make full use of the existing spatio-temporal historical data, and can model discontinuous traffic event sequence data to provide accurate and efficient traffic event prediction.

### BRIEF DESCRIPTION OF THE DRAWINGS

FIG. 1 is a flow chart of a method of predicting traffic events based on a spatio-temporal Hawkes process according to the present disclosure.

### DETAILED DESCRIPTION OF THE EMBODIMENTS

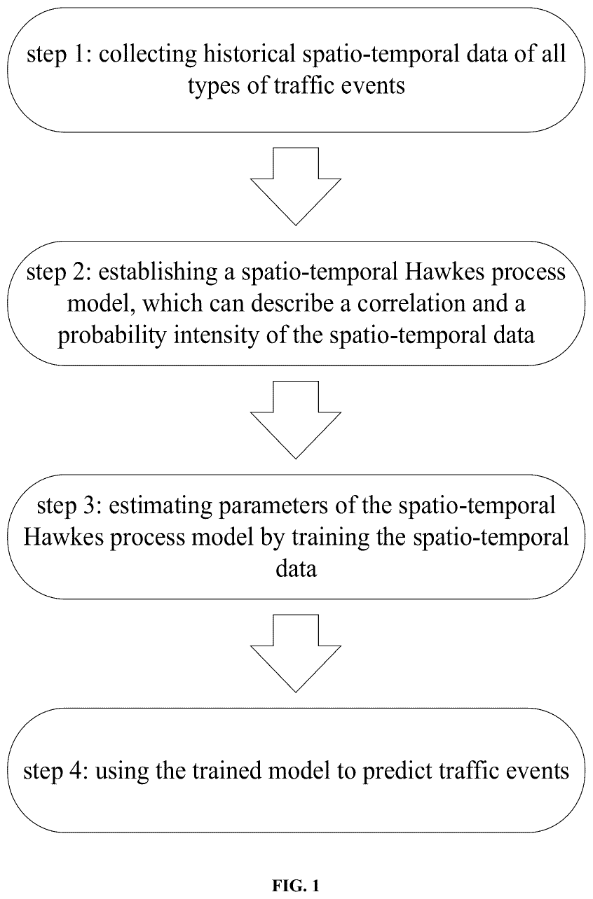

The method of predicting traffic events based on the spatio-temporal Hawkes process provided by the present disclosure will be explained in detail hereinafter. The flow chart of the method provided by the present disclosure is shown in FIG. 1, including the following steps.

Step 1: historical spatio-temporal data of all types of traffic events is collected; specifically the historical spatio-temporal data of n types of traffic events is expressed as E={E¹, E², . . . , E^{k}, . . . , Eⁿ}, a historical spatio-temporal sequence of a k-th type of traffic events is defined as E^{k}={e₁^{k}, e₂^{k}, . . . , eᵢ^{k}, . . . , e_{|E}_{ₖ}_{|}^{k}}, where eᵢ^{k}=(tᵢ^{k}, lᵢ^{k}), and tᵢ^{k} and lᵢ^{k}=(laᵢ^{k}, loᵢ^{k}) are timestamp information and spatial latitude and longitude information when a traffic event eᵢ^{k} occurs, respectively (laᵢ^{k} is longitude information of event eᵢ^{k}, and loᵢ^{k} is latitude information of event eᵢ^{k}).

Step 2: a spatio-temporal Hawkes process model is established. The model can describe the correlation of various events in spatio-temporal data and the probability intensity of a certain traffic event; specifically, given the historical spatio-temporal data E of all n types of traffic events, the spatio-temporal Hawkes process model is constructed, and the probability intensity of the k-th type of target traffic event eⱼ^{k} occurring in the target timestamp tⱼ^{k} and the target spatial latitude and longitude lⱼ^{k} is modeled as:

$${λ}_{{e}_{j}^{k} \vert E} ( {t}_{j}^{k} , {l}_{j}^{k} ) = {f}_{l} ( {μ}_{k} + {\sum }_{{e}_{h}^{k} ∈ {E}^{k} , h < j} {f}_{1} ( {e}_{j}^{k} , {e}_{h}^{k} ) + {\sum }_{{e}_{h}^{{k}^{′}} ∈ E - {E}^{k} , m < j} {f}_{2} ( {e}_{j}^{k} , {e}_{m}^{{k}^{′}} ) ) ,$$

where μₖ is a particular base probability intensity for occurrence of the k-th type of traffic events e^{k}, each type of traffic events has a particular base probability intensity;

$${\sum }_{{e}_{h}^{k} ∈ {E}^{k} , h < j} {f}_{1} ( {e}_{j}^{k} , {e}_{h}^{k} )$$

indicates a summation for influences of the same type of historical traffic events eₕ^{k} ∈E^{k} on the target traffic event eⱼ^{k}, f₁(·,·) is a spatio-temporal influence function for the same type of traffic events,

$${\sum }_{{e}_{m}^{{k}^{′}} ∈ E - {E}^{k} , m < j} {f}_{2} ( {e}_{j}^{k} , {e}_{m}^{{k}^{′}} )$$

is a summation for influences of other types of historical traffic events eₘ^{k′}∈E−E^{k} on the target traffic event eⱼ^{k}, f₂(·,·) is a spatio-temporal influence function for different types of traffic events, and fₗ(x)=1/(1+exp(−x)) is a logistic function, which is used to improve the non-linear feature extraction ability of the model and ensure the non-negativity of the probability intensity.

It should be noted that in practical application, all or part of historical event data can be selected for modeling and solving according to actual demands.

Specifically, the influence function of the same type of traffic events eₕ^{k} ∈E^{k} on the target traffic event eⱼ^{k} is defined as:

$${f}_{1} ( {e}_{j}^{k} , {e}_{h}^{k} ) = φ ( {t}_{j}^{k} , {t}_{h}^{k} ) \cdot d ( {l}_{j}^{k} , {l}_{h}^{k} ) \cdot {γ}_{k} ,$$

where φ(tⱼ^{k}, tₕ^{k})=exp (−αₖ·(tⱼ^{k}−tₕ^{k}) indicates that the influence of the same type of historical traffic events decays exponentially with an increasing time interval, αₖ is a time attenuation degree coefficient for the influence of the same type (k) of events, the larger the value of αₖ, the higher the corresponding attenuation degree;

$$d ( {l}_{j}^{k} , {l}_{h}^{k} ) = exp ( {β}_{k} \cdot \sqrt{{( {la}_{j}^{k} , {la}_{h}^{k} )}^{2} + {( {lo}_{j}^{k} , {lo}_{h}^{k} )}^{2}} )$$

indicates that the influence of the same type of historical traffic events decays exponentially with an increasing space interval, laⱼ^{k} and loⱼ^{k} are the spatial longitude and latitude information of the target traffic event, laₕ^{k} and loₕ^{k} are the longitude information and latitude information of the same type of historical traffic events eₕ^{k} ∈E^{k}, βₖ is a space attenuation degree coefficient for the influence of the same type of events (k), the larger the value of βₖ, the higher the corresponding attenuation degree, and γₖ is a real number parameter.

In this embodiment, γₖ<0 indicates that the relationship between the same type of events is negatively correlated (suppression effect), and γₖ>0 indicates that the relationship between the same type of events is positively correlated (stimulation effect). If the time or space information is missing for a certain historical event, the corresponding function is assigned a value of 1.

Similarly, the influence function of other types of historical traffic events eₘ^{k′}∈E−E^{k} on the target traffic event eⱼ^{k} is defined as:

$${f}_{2} ( {e}_{j}^{k} , {e}_{m}^{{k}^{′}} ) = {φ}^{′} ( {t}_{j}^{k} , {t}_{m}^{{k}^{′}} ) \cdot {d}^{′} ( {l}_{j}^{k} , {l}_{m}^{{k}^{′}} ) \cdot {γ}_{k}^{{k}^{′}} ,$$

where φ′(tⱼ^{k}, tₘ^{k′})=exp (−αₖ^{k′}·(tⱼ^{k}−tₘ^{k′})) indicates that the influence of the different types of historical traffic events decays exponentially with the increasing time interval, αₖ^{k′} is the time attenuation degree coefficient for the influence of a k′-th type of the historical event on the k-th type of the target event,

$${d}^{′} ( {l}_{j}^{k} , {l}_{m}^{{k}^{′}} ) = exp ( {β}_{k}^{{k}^{′}} \cdot \sqrt{{( {la}_{j}^{k} , {la}_{m}^{{k}^{′}} )}^{2} + {( {lo}_{j}^{k} , {lo}_{m}^{{k}^{′}} )}^{2}} )$$

indicates that the influence of the same type of historical traffic events decays exponentially with the increasing space interval, laⱼ^{k} and loⱼ^{k} are the longitude and latitude information of the target space, laₘ^{k′} and loₘ^{k′} are the longitude and latitude information of the different types of the historical traffic events e^{k} ∈E−E^{k}, βₖ^{k′} is the space attenuation degree coefficient for the influence of the k′-th type of events on the k-th type of events, and γₖ^{k′} is a real number parameter.

In this embodiment, γₖ^{k′}<0 indicates that the relationship between different types of events is negatively correlated (suppression effect), and γₖ^{k′}>0 indicates that the relationship between different types of events is positively correlated (stimulation effect).

Step 3: parameters of the spatio-temporal Hawkes process model are estimated by training the spatio-temporal data. Specifically, an objective function for estimating the parameters of the spatio-temporal Hawkes process model is formally defined as:

$$O = {\sum }_{{E}^{k} ∈ E} {\sum }_{{e}_{j}^{k} ∈ {E}^{k}} log p ( {e}_{j}^{k} \vert E , {t}_{j}^{k} , {l}_{j}^{k} ) ,$$

where p(eⱼ^{k}|E, tⱼ^{k}, lⱼ^{k}) is a probability of occurrence of the k-th type of target traffic event eⱼ^{k} in time tⱼ^{k} and space lⱼ^{k} given the historical spatio-temporal data E of all n types of traffic events, which is formally defined as:

$$p ( {e}_{j}^{k} \vert E , {t}_{j}^{k} , {l}_{j}^{k} ) = \frac{{λ}_{{e}_{j}^{k} \vert E} ( {t}_{j}^{k} , {l}_{j}^{k} )}{{\sum }_{{k}^{′} ∈ [ 1 , 2 , … , n ]} {λ}_{{e}^{{k}^{′}} \vert E} ( {t}_{j}^{k} , {l}_{j}^{k} )} ,$$

Where

$${λ}_{{e}_{j}^{k} \vert E} ( {t}_{j}^{k} , {l}_{j}^{k} )$$

represents the probability intensity of occurrence of the k-th type of the target traffic event in time tⱼ^{k} and space lⱼ^{k}, and

$${λ}_{{e}^{{k}^{′}} \vert E} ( {t}_{j}^{k} , {l}_{j}^{k} )$$

represents the probability intensity of occurrences of other types of target traffic events in time tⱼ^{k} and space lⱼ^{k}.

Furthermore, the above objective function O is maximally solved using a gradient descent optimization algorithm, so as to obtain the optimal values of all parameters and obtain the final spatio-temporal Hawkes process model.

Step 4: the trained model is used to predict traffic events.

Specifically, the process of predicting traffic events by using the trained model is defined as given time information t and space information l, the probabilities of occurrences of all n types of traffic events are calculated and sorted in a descending order of probability values, and finally the sorted event list and probability values are output.

In this embodiment, given the time information t and the space information l, the probability of occurrence of the k-th type of events (k∈[1, 2, 3, . . . , n]) is defined as:

$$p ( {e}^{k} \vert E , t , l ) = \frac{{λ}_{{e}^{k} \vert E} ( t , l )}{{\sum }_{{k}^{′} ∈ [ 1 , 2 , … , n ]} {λ}_{{e}^{{k}^{′}} \vert E} ( t , l )} ,$$

$${λ}_{{e}^{k} \vert E} ( t , l ) = {f}_{l} ( {μ}_{k} + {\sum }_{{e}_{h}^{k} ∈ {E}^{k} , h < j} {f}_{1} ( {e}^{k} , {e}_{h}^{k} ) + {\sum }_{{e}_{m}^{{k}^{″}} ∈ E - {E}^{k} , m < j} {f}_{2} ( {e}^{k} , {e}_{m}^{{k}^{″}} ) ) ,$$

$${λ}_{{e}^{{k}^{′}} \vert E} ( t , l ) = {f}_{l} ( {μ}_{{k}^{′}} + {\sum }_{{e}_{h}^{{k}^{′}} ∈ {E}^{{k}^{′}} , h < j} {f}_{1} ( {e}^{{k}^{′}} , {e}_{h}^{{k}^{′}} ) + {\sum }_{{e}_{m}^{{k}^{″}} ∈ E - {E}^{{k}^{′}} , m < j} {f}_{2} ( {e}^{{k}^{′}} , {e}_{m}^{{k}^{″}} ) ) .$$

On this basis, the probabilities of occurrences of all n types of traffic events are sorted in a descending order of probability values, and finally the sorted event list and probability values are output.

The embodiments of the present disclosure have been described in detail above with reference to the drawings, but the present disclosure is not limited to the described embodiments. It will be obvious to those skilled in the art that various changes, modifications, substitutions and variations can be made to these embodiments, including components, without departing from the principle and spirit of the present disclosure, which still fall within the protection scope of the present disclosure.

What is claimed is:

1. A method of predicting traffic events based on a spatio-temporal Hawkes process, comprising:
step 1: collecting historical spatio-temporal data of all types of traffic events, and defining historical spatio-temporal data of n types of traffic events as E={E¹, E², . . . , E^{k}, . . . , Eⁿ}, wherein a historical spatio-temporal sequence of a k-th type of traffic events is defined as E^{k}={e₁^{k}, e₂^{k}, . . . , eᵢ^{k}, . . . , e_{|E}_{ₖ}_{|}^{k}}, wherein eᵢ^{k}=(tᵢ^{k}, lᵢ^{k}), and tᵢ^{k} and lᵢ^{k}=(laᵢ^{k}, loᵢ^{k}) are timestamp information and spatial latitude and longitude information when a traffic event eᵢ^{k} occurs, respectively, laᵢ^{k} is longitude information of event eᵢ^{k}, and loᵢ^{k} is latitude information of event eᵢ^{k};
step 2: establishing a spatio-temporal Hawkes process model with a following expression:
$${λ}_{{e}_{j}^{k} \vert E} ( {t}_{j}^{k} , {l}_{j}^{k} ) = {f}_{l} ( {μ}_{k} + {\sum }_{{e}_{h}^{k} ∈ {E}^{k} , h < j} {f}_{1} ( {e}_{j}^{k} , {e}_{h}^{k} ) + {\sum }_{{e}_{m}^{{k}^{′}} ∈ E - {E}^{k} , m < j} {f}_{2} ( {e}_{j}^{k} , {e}_{m}^{{k}^{′}} ) ) ,$$
where μₖ is a base probability intensity for occurrence of the k-th type of traffic events e^{k},
$${\sum }_{{e}_{h}^{k} ∈ {E}^{k} , h < j} {f}_{1} ( {e}_{j}^{k} , {e}_{h}^{k} )$$
indicates an influence of a same type of historical traffic events eₕ^{k}∈E^{k} on a target traffic event eⱼ^{k}, f₁(·,·) is an influence function of the same type of traffic events,
$${\sum }_{{e}_{m}^{{k}^{′}} ∈ E - {E}^{k} , m < j} {f}_{2} ( {e}_{j}^{k} , {e}_{m}^{{k}^{′}} )$$
is an influence of other types of historical traffic events eₘ^{k′}∈E−E^{k} on the target traffic event eⱼ^{k}, f₂(·,·) is an influence function of different types of traffic events, and fₗ(x)=1/(1+exp(−x)) is a logistic function;
step 3: estimating parameters of the spatio-temporal Hawkes process model by training the spatio-temporal data; and
step 4: using the trained model to predict traffic events.

2. The method of predicting traffic events based on the spatio-temporal Hawkes process according to claim 1, wherein the influence of the same type of traffic events on the target traffic event comprises a negative correlation and a positive correlation, the negative correlation acts as a suppression effect and the positive correlation acts as a stimulation effect.

3. The method of predicting traffic events based on the spatio-temporal Hawkes process according to claim 2, wherein in step 2,
an influence function of the same type of traffic events eₕ^{k}∈E^{k} on the target traffic event eⱼ^{k} is defined as:
$${f}_{1} ( {e}_{j}^{k} , {e}_{h}^{k} ) = φ ( {t}_{j}^{k} , {t}_{h}^{k} ) \cdot d ( {l}_{j}^{k} , {l}_{h}^{k} ) \cdot {γ}_{k} ,$$
where φ(tⱼ^{k}, tₕ^{k})=exp (−αₖ·(tⱼ^{k}−tₕ^{k}) indicates that the influence of the same type of historical traffic events decays exponentially with an increasing time interval, αₖ is a time attenuation degree coefficient for the influence of the same type (k) of events, d(lⱼ^{k}, lₕ^{k})=exp(−βₖ·\sqrt{(laⱼ^{k}−laₕ^{k}k)²+(loⱼ^{k}−loₕ^{k})²}) indicates that the influence of the same type of historical traffic events decays exponentially with an increasing space interval, laⱼ^{k} and loⱼ^{k} are spatial longitude and latitude information of the target traffic event, laₕ^{k} and loₕ^{k} are longitude and latitude information of the same type of historical traffic events eₕ^{k} ∈E^{k}, βₖ is a space attenuation degree coefficient for the influence of the same type of events, and γₖ is a real number parameter.

4. The method of predicting traffic events based on the spatio-temporal Hawkes process according to claim 3, wherein in the influence function of the same type of traffic events eₕ^{k}∈E^{k} on the target traffic event eⱼ^{k}, γₖ indicates whether a relationship between different types of events is negatively correlated or positively correlated.

5. The method of predicting traffic events based on the spatio-temporal Hawkes process according to claim 2, wherein in step 2,
an influence function of the other types of historical traffic events eₘ^{k′}∈E−E^{k} on the target traffic event eⱼ^{k} is defined as:
$${f}_{2} ( {e}_{j}^{k} , {e}_{m}^{{k}^{′}} ) = {φ}^{′} ( {t}_{j}^{k} , {t}_{m}^{{k}^{′}} ) \cdot {d}^{′} ( {l}_{j}^{k} , {l}_{m}^{{k}^{′}} ) \cdot {γ}_{k}^{{k}^{′}} ,$$
where φ′(tⱼ^{k}, tₘ^{k′})=exp (−αₖ^{k′}·(tⱼ^{k}−tₘ^{k′}) indicates that the influence of the different types of historical traffic events decays exponentially with the increasing time interval, αₖ^{k′} is a time attenuation degree coefficient for the influence of a k′-th type of the historical events on the k-th type of the target event,
$${d}^{′} ( {l}_{j}^{k} , {l}_{m}^{{k}^{′}} ) = exp ( - {β}_{k}^{{k}^{′}} \cdot \sqrt{{( l {a}_{j}^{k} - l {a}_{m}^{{k}^{′}} )}^{2} + {( {lo}_{j}^{k} - {lo}_{m}^{{k}^{′}} )}^{2}} )$$
indicates that the influence of the same type of historical traffic events decays exponentially with the increasing space interval, laⱼ^{k} and loⱼ^{k}k are the spatial longitude and latitude information of the target traffic event eⱼ^{k}, laₘ^{k′} and loₘ^{k′} are the spatial longitude and latitude information of the different types of the historical traffic events eₘ^{k}∈E−E^{k}, βₖ^{k′} is a space attenuation degree coefficient for the influence of a k′-th type of events on the k-th type of events, and γₖ^{k′} is a real number parameter.

6. The method of predicting traffic events based on the spatio-temporal Hawkes process according to claim 5, wherein in the influence function of the other type of the historical traffic events eₘ^{k′}∈E−E^{k} on the target traffic event eⱼ^{k}, γₖ^{k′} indicates whether the relationship between the different types of events is negatively correlated or positively correlated.

7. The method of predicting traffic events based on the spatio-temporal Hawkes process according to claim 1, wherein in step 3, the spatio-temporal Hawkes process model is constructed according to operations comprising:
first, defining an objective function for estimating the parameters of the spatio-temporal Hawkes process model as:
$$O = {\sum }_{{E}^{k} ∈ E} {\sum }_{{e}_{j}^{k} ∈ {E}^{k}} log p ( {e}_{j}^{k} \vert E , {t}_{j}^{k} , {l}_{j}^{k} ) ,$$
where p(eⱼ^{k}|E, tⱼ^{k}, lⱼ^{k}) is a probability of occurrence of the k-th type of the target traffic event eⱼ^{k} in time tⱼ^{k} and space lⱼ^{k} given the historical spatio-temporal data E of all n types of traffic events,
furthermore, maximally solving the objective function O by using a gradient descent optimization algorithm to obtain optimal values of all parameters and obtain a final spatio-temporal Hawkes process model.

8. The method of predicting traffic events based on the spatio-temporal Hawkes process according to claim 7, wherein in step 4, the process of predicting traffic events by using the trained model is defined as given time information t and space information l, probabilities of occurrences of all n types of traffic events are calculated and sorted in a descending order of probability values, and finally the sorted event list and probability values are output.
